(19) United States
(12) Patent Application Publication
(10) Pub. No.: US 2024/0205274 A1
(43) Pub. Date: Jun. 20, 2024

(54) METHODS AND SYSTEMS FOR MANAGING PACKET TRANSMISSIONS

(71) Applicant: QUALCOMM Incorporated, San Diego, CA (US)

(72) Inventors: Md Ibrahim KHALIL, San Diego, CA (US); Yih-Hao LIN, San Diego, CA (US); Peerapol TINNAKORNSRISUPHAP, San Diego, CA (US); Vinesh DHANARAJ, San Diego, CA (US)

(21) Appl. No.: 18/069,087

(22) Filed: Dec. 20, 2022

(51) Int. Cl. H04L 65/1108; H04L 65/65; H04W 28/16

(52) U.S. Cl. CPC H04L 65/1108; H04L 65/65; H04W 28/16

(57) ABSTRACT

Embodiments of systems and methods for managing packet transmissions between the base station and a user equipment (UE) may include analyzing, by a base station, one or more conditions of a wireless link between the base station and the UE in response to receiving Web Real-Time Communication (WebRTC) packets for transmission to the UE, such as over the Stream Control Transmission Protocol (SCTP), and selecting a mode for transmitting the WebRTC packets to the UE based on whether the one or more conditions of the wireless link between the base station and the UE meets a respective condition threshold.

### BACKGROUND

Long Term Evolution (LTE), Fifth Generation (5G) New Radio (NR), and other communication technologies enable improved communication and data services. One such service is low latency real-time data streaming, which may be used to support latency sensitive applications, such as online gaming, voice and video conferencing, and other suitable applications. Some services require the installation on an endpoint device of a dedicated application that may include customized information and protocols to perform data streaming communications. However, a more flexible and generic approach involves the provision of real-time data streaming via a web browser application, which does not require the processing burden or memory consumption incurred by using a dedicated data streaming application.

### SUMMARY

Various aspects include systems and methods performed by a base station for managing packet transmissions to a user equipment (UE). In some embodiments, the base station may analyze one or more conditions of a wireless link between the base station and the UE in response to receiving Web Real-Time Communication (WebRTC) packets for transmission to the UE, and select a mode (e.g., an internet protocol (IP) packet delivery mode) for transmitting the WebRTC packets to the UE based on whether the one or more conditions of the wireless link between the base station and the UE meets a respective condition threshold. In some embodiments, the base station may receive the WebRTC packets for transmission to the UE via an RTC peer connection or a Data Channel using, for example, Stream Control Transmission Protocol (SCTP) or another suitable protocol.

In some aspects, analyzing the one or more conditions of the wireless link between the base station and the UE in response to receiving WebRTC packets for transmission to the UE may include determining whether received packets are WebRTC packets, and analyzing the one or more conditions of the wireless link between the base station and the UE in response to determining that the received packets are WebRTC packets. In some aspects, analyzing the one or more conditions of the wireless link between the base station and the UE in response to receiving WebRTC packets for transmission to the UE may include determining whether received packets for transmission to the UE are SCTP packets, and analyzing the one or more conditions of the wireless link between the base station and the UE in response to determining that the received packets are SCTP packets.

In some aspects, analyzing the one or more conditions of the wireless link between the base station and the UE may include determining whether a signal condition of the wireless link between the base station and the UE meets a signal condition threshold. In some aspects, analyzing the one or more conditions of the wireless link between the base station and the UE may include determining whether a data carriage capacity of the wireless link between the base station and the UE meets a carriage capacity threshold. In some aspects, selecting the mode for transmitting the WebRTC packets to the UE may include selecting a Radio Link Control (RLC) timer that is different from a default RLC timer and a Packet Data Convergence Protocol (PDCP) timer that is different from a default PDCP timer in response to determining that the data carriage capacity of the wireless link between the base station and the UE does not meet the carriage capacity threshold. In some aspects, selecting the mode for transmitting the WebRTC packets to the UE may include transmitting the WebRTC packets to the UE using a PDCP out-of-order delivery (OOOD) mode in response to determining that the data carriage capacity of the wireless link between the base station and the UE meets the carriage capacity threshold.

Further aspects include a base station having a processor configured to perform one or more operations of any of the methods summarized above. Further aspects include processing devices for use in a base station configured with processor-executable instructions to perform operations of any of the methods summarized above. Further aspects include a non-transitory processor-readable storage medium having stored thereon processor-executable instructions configured to cause a processor of a base station to perform operations of any of the methods summarized above. Further aspects include a base station having means for performing functions of any of the methods summarized above. Further aspects include a system on chip for use in a base station and that includes a processor configured to perform one or more operations of any of the methods summarized above.

Various aspects include systems and methods performed by a UE for managing packet transmissions from a base station. In some embodiments, the UE may analyze one or more conditions of a wireless link between the UE and the base station for receiving WebRTC packets from the base station, and select a mode for receiving the WebRTC packets from the base station based on whether the one or more conditions of the wireless link between the base station and the UE meets a respective condition threshold.

In some aspects, analyzing the one or more conditions of the wireless link between the UE and the base station for receiving WebRTC packets from the base station may include determining whether a signal condition of the wireless link between the UE and the base station meets a signal condition threshold. In some aspects, analyzing the one or more conditions of the wireless link between the UE and the base station for receiving WebRTC packets from the base station may include determining whether a data carriage capacity of the wireless link between the UE and the base station meets a carriage capacity threshold.

In some aspects, selecting the mode for receiving the WebRTC packets from the base station may include selecting an RLC timer that is different from a default RLC timer and a PDCP timer that is different from a default PDCP timer in response to determining that the data carriage capacity of the wireless link between the UE and the base station does not meet the carriage capacity threshold. In some aspects, selecting the mode for receiving the WebRTC packets from the base station may include selecting an RLC timer that is different from a default RLC timer and a PDCP timer that is different from a default PDCP timer and receiving the WebRTC packets using a PDCP out-of-order delivery (OOOD) mode in response to determining that the data carriage capacity of the wireless link between the UE and the base station meets the carriage capacity threshold. In some aspects, analyzing the one or more conditions of the wireless link between the UE and the base station for receiving WebRTC packets from the base station may include analyzing the one or more conditions of the wireless link between the UE and the base station for receiving WebRTC packets from the base station via an RTC peer connection or a Data Channel using SCTP. Some aspects may further include providing received WebRTC packets to an application executing in the UE according to the selected mode.

Further aspects include a UE having a processor configured to perform one or more operations of any of the methods summarized above. Further aspects include processing devices for use in a UE configured with processor-executable instructions to perform operations of any of the methods summarized above. Further aspects include a non-transitory processor-readable storage medium having stored thereon processor-executable instructions configured to cause a processor of a UE to perform operations of any of the methods summarized above. Further aspects include a UE having means for performing functions of any of the methods summarized above. Further aspects include a system on chip for use in a UE and that includes a processor configured to perform one or more operations of any of the methods summarized above.

### BRIEF DESCRIPTION OF THE DRAWINGS

FIG. 1A is a system block diagram illustrating an example communications system suitable for implementing any of the various embodiments.

FIG. 1B is a system block diagram illustrating an example disaggregated base station architecture suitable for implementing any of the various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4A is a block diagram illustrating an example communication system suitable for implementing any of the various embodiments.

FIG. 4B is a block diagram illustrating an example protocol stack suitable for implementing any of the various embodiments.

FIG. 5A is a process flow diagram illustrating a method that may be performed by a processor of a base station for managing packet transmissions to a UE in accordance with various embodiments.

FIG. 5B is a process flow diagram illustrating operations that may be performed as part of the method for managing packet transmissions to a UE in accordance with various embodiments.

FIG. 6A is a process flow diagram illustrating a method that may be performed by a processor of a UE for managing packet transmissions to a base station in accordance with various embodiments.

FIG. 6B is a process flow diagram illustrating operations that may be performed as part of the method for managing packet transmissions to a base station in accordance with various embodiments.

FIG. 7 is a component block diagram of a UE suitable for use with various embodiments.

FIG. 8 is a component block diagram of a network device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments enable a base station and a UE to increase the efficiency of streaming data packet communication, such as for latency sensitive (low latency) applications. Various embodiments improve the operation and performance of browser-based applications and services that require relatively low latency (for example, a minimum data throughput, a minimum data rate, or another suitable parameter).

The term “user equipment” (UE) is used herein to refer to any one or all of wireless communication devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, wireless router devices, medical devices and equipment, biometric sensors/devices, wearable devices including smart watches, smart clothing, smart glasses, smart wrist bands, smart jewelry (for example, smart rings and smart bracelets), entertainment devices (for example, wireless gaming controllers, music and video players, satellite radios, etc.), wireless-network enabled Internet of Things (IOT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, and similar electronic devices that include a memory, wireless communication components and a programmable processor.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement Enhanced Data rates for Global System for Mobile communications (GSM) Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

Providing real-time (e.g., low latency) data streaming services in a UE through a web browser application is efficient, particularly for applications or services that require high data rates and/or low latency, such as online gaming, multimedia streaming, video conferencing, and other suitable applications. Data streaming via a browser application enables a UE to support (execute, provide) such low latency applications and services without incurring the processing burden or memory consumption of a dedicated data streaming application installed in the UE. Dedicated applications typically must be configured with all of the information, protocol stacks, and other aspects required to enable data streaming communications. Consequently, dedicated applications typically require more memory for their storage and may require more burdensome processing operations to execute.

To support low latency data streaming, a browser application may utilize lightweight and flexible scheme such as the Web Real-Time Communication (WebRTC), which may employ transport protocol such as Stream Control Transmission Protocol (SCTP) or Secure Real-Time Transport Protocol (SRTP). In some implementations, WebRTC may enable audio and video communications within a web page by providing application programming interfaces (APIs) configured to enable, for example, peer-to-peer communication between computing devices. Implementing WebRTC may eliminate the need to install a plug-in or dedicated application configured to enable low latency data streaming services.

However, SCTP-based data streaming via a web browser application may be susceptible to head-of-line (HOL) blockage at certain layers of an applicable protocol stack, such as the Packet Data Convergence Protocol (PDCP) layer or the Radio Link Control (RLC) layer, which may increase streaming data tail latencies and/or decrease streaming data throughput. For example, a 5G (i.e., NR) wireless communication link default bearer may be configured to deliver data packets in order, so parameters of the wireless communication link must be properly configured to enable streaming data packet transmissions that meets an applicable latency (throughput) requirement (such as a minimum throughput requirement, or minimum data rate requirement, of a data streaming service). In poor radio frequency (RF) conditions, such as conditions that decrease a signal-to-noise ratio (SNR) or a Receive Signal Reference Power (RSRP) or when a UE is distant from a cell (base station), SCTP performance may decrease dramatically, particularly when congestion control operations are performed. Further, inefficient SCTP layer retransmissions may cause video streaming to suffer. Such processing latency incurred by data processing at the SCTP layer decreases the efficacy of SCTP for video streaming over wireless communication links. To use protocols such as SCTP for low latency data streaming, wireless communication link parameters must be properly configured (tuned), in particular to provide at least a minimum throughput or data rate even in poor RF conditions.

Various embodiments include methods, and base stations and UEs configured to perform the methods, for managing packet transmission, such as for low latency data streaming (e.g., of data packets). Various embodiments improve the performance of protocols such as SCTP, and may be implemented flexibly, such as via a cross-layer API, or via smart configuration of a base station. In some embodiments, a base station may be configured to analyze one or more conditions of a wireless link between the base station and a UE in response to receiving WebRTC packets for transmission to the UE, and may select a mode for transmitting the WebRTC packets to the UE based on whether the one or more conditions of the wireless link between the base station and the UE meets a respective condition threshold. In some embodiments, the base station may receive the WebRTC packets for transmission to the UE via an RTC peer connection or a Data Channel using, for example, Stream Control Transmission Protocol (SCTP) or another suitable protocol.

In some embodiments, the base station may be configured to classify a traffic type and to configure network parameters according to the determined traffic type. In some embodiments, the base station may determine whether the received packets are WebRTC packets, and may analyze the one or more conditions of the wireless link between the base station and the UE in response to determining that the received packets are WebRTC packets. In some embodiments, the base station may determine whether the received packets for transmission to the UE are SCTP packets, and may analyze the one or more conditions of the wireless link between the base station and the UE in response to determining that the received packets are SCTP packets. In some embodiments, the base station may determine whether a signal condition of the wireless link between the base station and the UE meets a signal condition threshold. In some embodiments, the base station may determine whether a data carriage capacity (for example, a data throughput) of the wireless link between the base station and the UE meets a carriage capacity threshold, such as a throughput threshold. In some embodiments, the carriage capacity threshold may include a minimum throughput requirement, such as a minimum throughput requirement for an application executing on the UE.

In some embodiments, the base station may perform operations to configure wireless communication link parameters to improve streaming data communications. In some embodiments, the base station may select a Radio Link Control (RLC) timer that is different from a default RLC timer and a Packet Data Convergence Protocol (PDCP) timer that is different from a default PDCP timer in response to determining that the data carriage capacity of the wireless link between the base station and the UE does not meet the carriage capacity threshold. For example, the base station may select the RLC timer that is different from a default RLC timer and the PDCP timer that is different from the default PDCP timer in response to determining that the data throughput of the wireless link between the base station and the UE does not meet (is less than, or less than or equal to) a minimum throughput threshold. In some embodiments, the base station may select an RLC timer and/or PDCP timer that is smaller (for a shorter period or duration of time) than a default RLC and/or PDCP timer. Using a smaller RLC timer and/or PDCP timer may improve tail latency and communication link reliability.

In some embodiments, the base station may transmit packets to the UE using a Packet Data Convergence Protocol (PDCP) out-of-order delivery (OOOD) mode in response to determining that the data carriage capacity of the wireless link between the base station and the UE meets the carriage capacity threshold. For example, the base station may transmit packets to the UE using the PDCP OOOD mode in response to determining that the data throughput of the wireless link between the base station and the UE meets (is greater than, or greater than or equal to) a minimum throughput threshold. In some embodiments, the base station may transmit packets to the UE in an order different from a packet rendering sequence or other packet ordering information. For example, the base station may transmit packets to the UE in an order in which the base station receives the packets from a source computing device that transmits the packets, which may be out of a packet sequence due to, for example, packet delays and/or packet loss. In some embodiments, the base station may transmit the packets to the UE without performing a reordering operation on the packets.

In some embodiments, the UE may be configured to analyze one or more conditions of a wireless link between the UE and the base station for receiving WebRTC packets from the base station, and select a mode for receiving the WebRTC packets from the base station based on whether the one or more conditions of the wireless link between the base station and the UE meets a respective condition threshold. In some embodiments, the UE may receive the WebRTC packets from the base station via an RTC peer connection or a Data Channel using, for example, Stream Control Transmission Protocol (SCTP) or another suitable protocol. In some embodiments, the UE may analyze the one or more conditions of the wireless link between the UE and the base station in response to determining that the packets to be received (or received) from the base station are WebRTC packets. In some embodiments, the UE may analyze the one or more conditions of the wireless link between the UE and the base station in response to determining that the packets to be received (or received) from the base station are SCTP packets. In some embodiments, the UE may determine whether a signal condition of the wireless link between UE and the base station meets a signal condition threshold. In some embodiments, UE may determine whether a data carriage capacity of the wireless link between the UE and the base station meets a carriage capacity threshold.

In some embodiments, in response to determining that the data carriage capacity of the wireless link between the UE and the base station does not meet the carriage capacity threshold, the UE may select a mode for receiving the WebRTC packets from the base station based on the one or more conditions of the wireless link. In some embodiments, the UE may select an RLC timer that is different from a default RLC timer and a PDCP timer that is different from a default PDCP timer. In some embodiments, in response to determining that the data carriage capacity of the wireless link between the UE and the base station meets the carriage capacity threshold, the UE may select an RLC timer that is different from a default RLC timer and a PDCP timer that is different from a default PDCP timer, and may receive the packets using a Packet Data Convergence Protocol (PDCP) out-of-order delivery (OOOD) mode. In some embodiments, the UE may select the PDCP OOOD mode based on the one or more conditions of the wireless link between the UE and the base station. In some embodiments, the UE may override default timers indicated by (e.g., governed by) the base station, and the UE may select the PDCP OOOD mode. In some embodiments, PDCP OOOD mode may enable the UE to provide received packets (e.g., WebRTC packets) to a media application executing on the UE in the order in which the packets are received by the UE. In such embodiments, the UE may not wait for the arrival of missing or delayed packets. Some embodiments may include providing the received WebRTC packets to the application executing in the UE according to the selected mode.

Various embodiments improve wireless communications of data packets for latency sensitive data streaming by enabling base stations and UEs to improve data throughput and/or data transmission rates. Various embodiments improve the operation of UEs base stations by reducing data streaming latency. Various embodiments improve the operation of UEs and base stations by decreasing head of line (HOL) blocking and improving PDCP layer throughput.

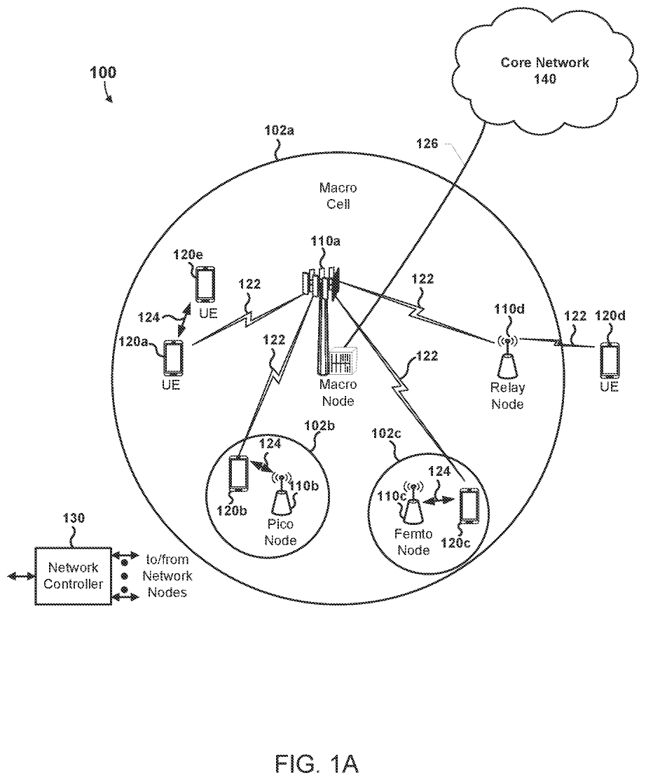

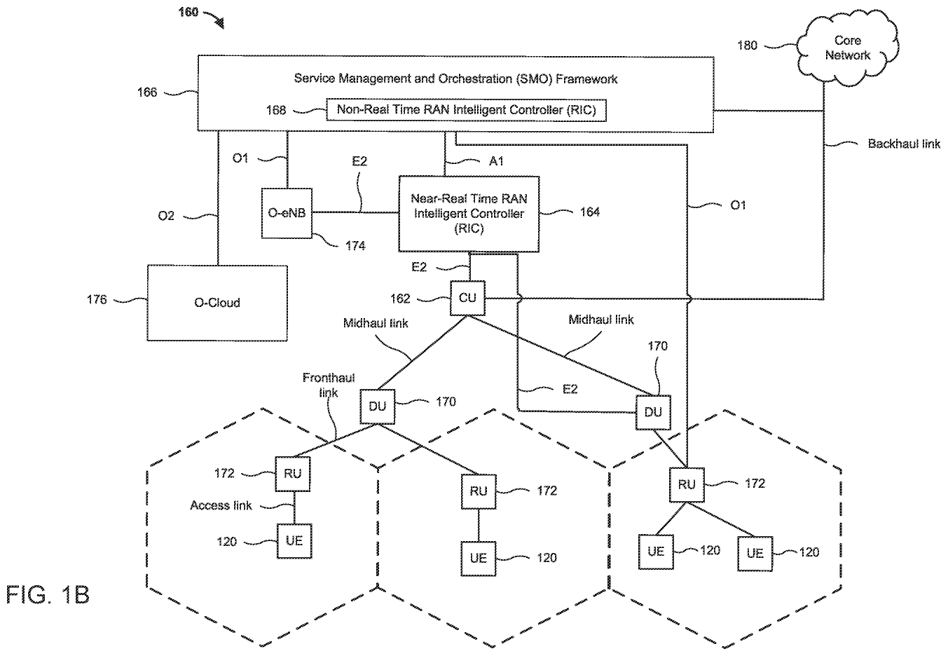

FIG. 1A is a system block diagram illustrating an example communications system 100 suitable for implementing any of the various embodiments. The communications system 100 may be a 5G New Radio (NR) network, or any other suitable network such as a Long Term Evolution (LTE) network. While FIG. 1A illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of UEs (illustrated as UEs 120a-120e in FIG. 1A). The communications system 100 also may include a number of network devices 110a, 110b, 110c, and 110d and other network entities, such as base stations and network nodes. A network device is an entity that communicates with UEs, and in various embodiments may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. In various communication network implementations or architectures, a network device may be implemented as an aggregated base station, as a disaggregated base station, an integrated access and backhaul (IAB) node, a relay node, a sidelink node, etc., such as a virtualized Radio Access Network (vRAN) or Open Radio Access Network (O-RAN). Also, in various communication network implementations or architectures, a network device (or network entity) may be implemented in an aggregated or monolithic base station architecture, or alternatively, in a disaggregated base station architecture, may include one or more of a Centralized Unit (CU), a Distributed Unit (DU), a Radio Unit (RU), a near-real time (RT) RAN intelligent controller (RIC), or a non-real time RIC. Each network device may provide communication coverage for a particular geographic area. In 3GPP, the term “cell” can refer to a coverage area of a network device, a network device subsystem serving this coverage area, or a combination thereof, depending on the context in which the term is used. The core network 140 may be any type core network, such as an LTE core network (e.g., an evolved packet core (EPC) network), 5G core network, etc.

A network device 110a-110d may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A network device for a macro cell may be referred to as a macro node or macro base station. A network device for a pico cell may be referred to as a pico node or a pico base station. A network device for a femto cell may be referred to as a femto node, a femto base station, a home node or home network device. In the example illustrated in FIG. 1A, a network device 110a may be a macro node for a macro cell 102a, a network device 110b may be a pico node for a pico cell 102b, and a network device 110c may be a femto node for a femto cell 102c. A network device 110a-110d may support one or multiple (for example, three) cells. The terms “network device,” “network node,” “eNB,” “base station,” “NR BS,” “gNB,” “TRP,” “AP,” “node B,” “5G NB,” and “cell” may be used interchangeably herein.

In some examples, a cell may not be stationary, and the geographic area of the cell may move according to the location of a network device, such as a network node or mobile network device. In some examples, the network devices 110a-110d may be interconnected to one another as well as to one or more other network devices (e.g., base stations or network nodes (not illustrated)) in the communications system 100 through various types of backhaul interfaces, such as a direct physical connection, a virtual network, or a combination thereof using any suitable transport network

The network device 110a-110d may communicate with the core network 140 over a wired or wireless communication link 126. The UE 120a-120e may communicate with the network node 110a-110d over a wireless communication link 122. The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay network device 110d). A relay station is an entity that can receive a transmission of data from an upstream station (for example, a network device or a UE) and transmit the data to a downstream station (for example, a UE or a network device). A relay station also may be a UE that can relay transmissions for other UEs. In the example illustrated in FIG. 1A, a relay station 110d may communicate with macro the network device 110a and the UE 120d in order to facilitate communication between the network device 110a and the UE 120d. A relay station also may be referred to as a relay network device, a relay base station, a relay, etc.

The communications system 100 may be a heterogeneous network that includes network devices of different types, for example, macro network devices, pico network devices, femto network devices, relay network devices, etc. These different types of network devices may have different transmit power levels, different coverage areas, and different impacts on interference in communications system 100. For example, macro nodes may have a high transmit power level (for example, 5 to 40 Watts) whereas pico network devices, femto network devices, and relay network devices may have lower transmit power levels (for example, 0.1 to 2 Watts).

A network controller 130 may couple to a set of network devices and may provide coordination and control for these network devices. The network controller 130 may communicate with the network devices via a backhaul. The network devices also may communicate with one another, for example, directly or indirectly via a wireless or wireline backhaul.

The UEs 120a, 120b, 120c may be dispersed throughout communications system 100, and each UE may be stationary or mobile. A UE also may be referred to as an access terminal, a terminal, a mobile station, a subscriber unit, a station, wireless device, etc.

A macro network device 110a may communicate with the communication network 140 over a wired or wireless communication link 126. The UEs 120a, 120b, 120c may communicate with a network device 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using Time Division Duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per UE. Multi-layer transmissions with up to 2 streams per UE may be supported.

Aggregation of multiple cells may be supported with up to eight serving cells. Alternatively, NR may support a different air interface, other than an OFDM-based air interface.

Some UEs may be considered machine-type communication (MTC) or evolved or enhanced machine-type communication (eMTC) UEs. MTC and eMTC UEs include, for example, robots, remote devices, sensors, meters, monitors, location tags, etc., that may communicate with a network device, another device (for example, remote device), or some other entity. A wireless computing platform may provide, for example, connectivity for or to a network (for example, a wide area network such as Internet or a cellular network) via a wired or wireless communication link. Some UEs may be considered Internet-of-Things (IOT) devices or may be implemented as NB-IOT (narrowband internet of things) devices. The UE 120a-120e may be included inside a housing that houses components of the UE 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an EPC network) in a 5G NSA network. Other example network configurations may include a 5G standalone (SA) network in which a 5G/NR RAN connects to a 5G core network.

In some implementations, two or more UEs 120a-120e (for example, illustrated as the UE 120a and the UE 120e) may communicate directly using one or more sidelink channels 124 (for example, without using a network node 110a-110d as an intermediary to communicate with one another). For example, the UEs 120a-120e may communicate using peer-to-peer (P2P) communications, device-to-device (D2D) communications, a mesh network, or similar networks, a vehicle-to-everything (V2X) protocol (which may include a vehicle-to-vehicle (V2V) protocol, a vehicle-to-infrastructure (V2I) protocol, or a similar protocol), or combinations thereof. In this case, the UE 120a-120e may perform scheduling operations, resource selection operations, as well as other operations described elsewhere herein as being performed by the network node 110a-110d.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or components) performing base station functionality, may be implemented in an aggregated or disaggregated architecture. For example, a base station (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or as a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, DUs and RUs also can be implemented as virtual units, referred to as a virtual central unit (VCU), a virtual distributed unit (VDU), or a virtual radio unit (VRU).

Base station-type operations or network design may consider aggregation characteristics of base station functionality. For example, disaggregated base stations may be utilized in an integrated access backhaul (IAB) network, an open radio access network (O-RAN) (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1B is a system block diagram illustrating an example disaggregated base station 160 architecture suitable for implementing any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, the UE 120 may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit—User Plane (CU-UP)), control plane functionality (i.e., Central Unit—Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based RAN architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via 01) or via creation of RAN management policies (such as A1 policies).

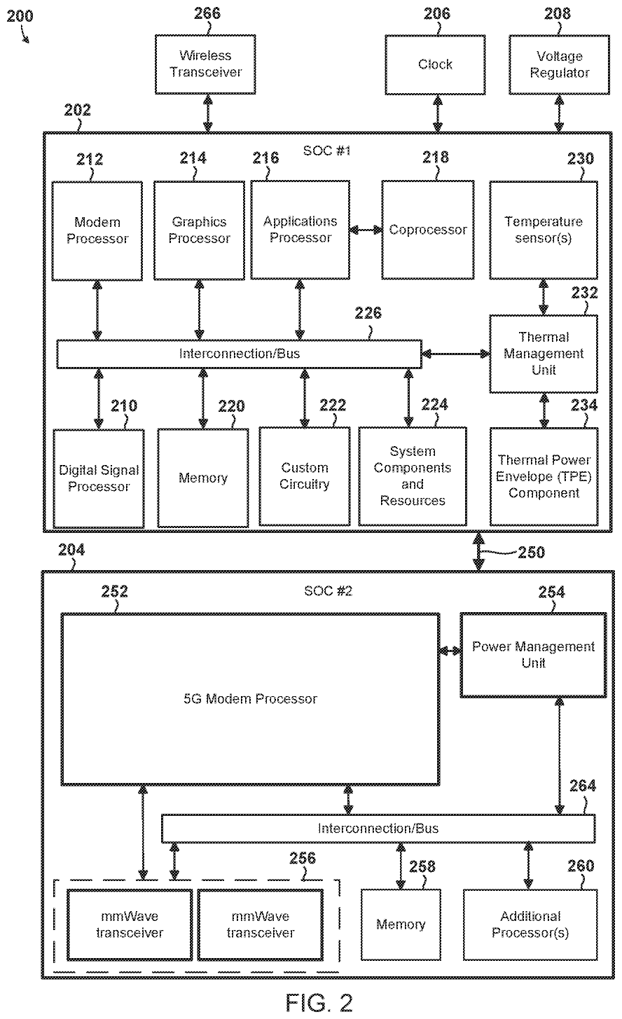

FIG. 2 is a component block diagram illustrating an example computing and wireless modem system 200 suitable for implementing any of the various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) includes a two SOCs 202, 204 coupled to a clock 206, a voltage regulator 208, and a wireless transceiver 266 configured to send and receive wireless communications via an antenna (not shown) to/from a UE (e.g., 120a-120e) or a network device (e.g., 110a-110d). In some implementations, the first SOC 202 may operate as central processing unit (CPU) of the UE that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), and/or very high frequency short wavelength (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mm Wave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a UE. The system components and resources 224 and/or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (such as CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

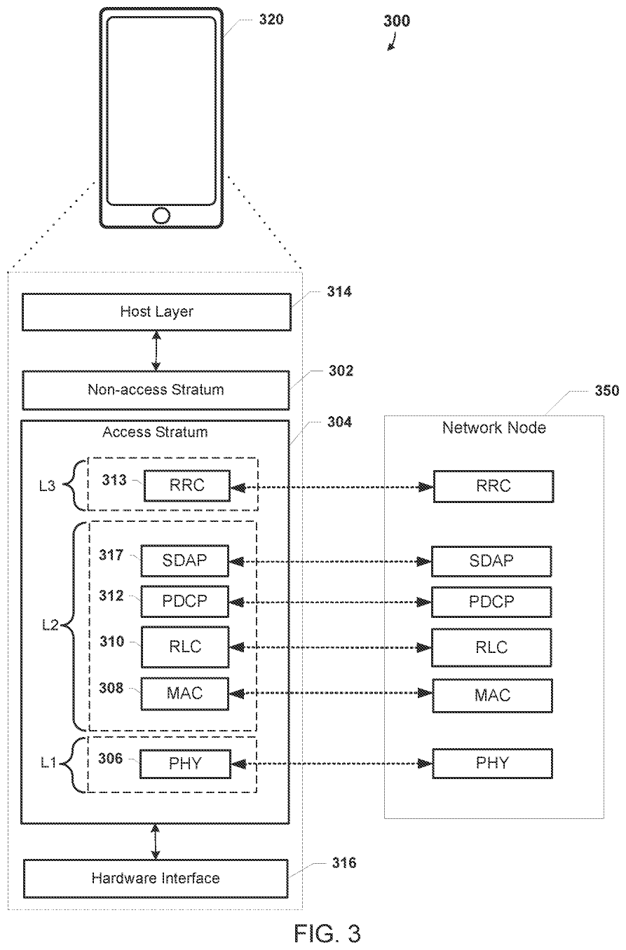

FIG. 3 is a component block diagram illustrating a software architecture 300 including a radio protocol stack for the user and control planes in wireless communications suitable for implementing any of the various embodiments. With reference to FIGS. 1A-3, the UE 320 may implement the software architecture 300 to facilitate communication between a UE 320 (e.g., the UE 120a-120e, 200) and the network device 350 (e.g., the network device 110a-110d) of a communication system (e.g., 100). In various embodiments, layers in software architecture 300 may form logical connections with corresponding layers in software of the network device 350. The software architecture 300 may be distributed among one or more processors (e.g., the processors 212, 214, 216, 218, 252, 260). While illustrated with respect to one radio protocol stack, in a UE having a multi-subscriber identity module (SIM), the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the UE (such as SIM(s) 204) and its core network 140. The AS 304 may include functions and protocols that support communication between a SIM(s) (such as SIM(s) 204) and entities of supported access networks (such as a network device, network node, RU, base station, etc.). In particular, the AS 304 may include at least three layers (Layer 1, Layer 2, and Layer 3), each of which may contain various sublayers.

In the user and control planes, Layer 1 (L1) of the AS 304 may be a physical layer (PHY) 306, which may oversee functions that enable transmission and/or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the UE 320 and the network node 350 over the physical layer 306. In some implementations, Layer 2 may include a media access control (MAC) sublayer 308, a radio link control (RLC) sublayer 310, and a packet data convergence protocol (PDCP) 312 sublayer, and a Service Data Adaptation Protocol (SDAP) 317 sublayer, each of which form logical connections terminating at the network node 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In some implementations, the RRC sublayer 313 may provide functions including broadcasting system information, paging, and establishing and releasing an RRC signaling connection between the UE 320 and the network node 350.

In various embodiments, the SDAP sublayer 317 may provide mapping between Quality of Service (QOS) flows and data radio bearers (DRBs). In some implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the UE 320. In some implementations, application-specific functions provided by the at least one host layer 314 may provide an interface between the software architecture and the general purpose processor (e.g., 202).

In other implementations, the software architecture 300 may include one or more higher logical layers (such as transport, session, presentation, application, etc.) that provide host layer functions. For example, in some implementations, the software architecture 300 may include a network layer (such as Internet Protocol (IP) layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency (RF) transceivers).

In various network implementations or architectures, in the network device 350 the different logical layers 308-317 may be implemented in an aggregated or monolithic base station architecture, or alternatively, in a disaggregated network device architecture, and various logical layers may implemented in one or more of a CU, a DU, an RU, a Near-RT RAN Intelligent Controller (RIC), or a Non-Real Time (Non-RT) RIC. Further, the network device 350 may be implemented as an aggregated base station, as a disaggregated base station, an integrated access and backhaul (IAB) node, a relay node, a sidelink node, etc.

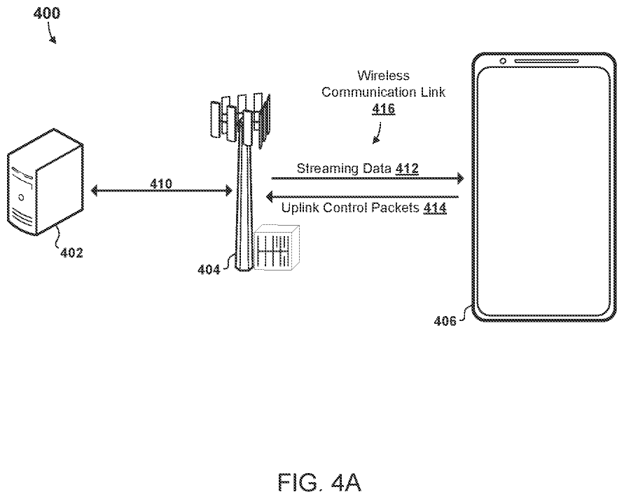

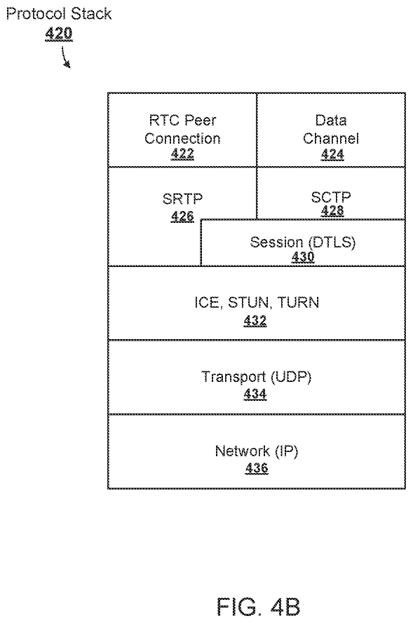

FIG. 4A is a block diagram illustrating an example communication system 400 suitable for implementing any of the various embodiments. The communications system 400 may be a 5G New Radio (NR) network, or any other suitable cellular network. With reference to FIGS. 1A-4A, references to a 5G network and 5G network elements in the following descriptions is for illustrative purposes and is not intended to be limiting, and previous or later generation networks may include the same or similar elements.

The communication system 400 may include a network element 402 such as a server 402 (e.g., which may be a network element in the core network 140), a base station 404 (e.g., 110a-110d, 350), and a UE 406 (e.g., 120a-120e, 320). In various embodiments, the server 402 and the UE 406 may communicate via the base station 404 to send and/or receive information that enables the UE 406 to execute an application using streaming data that the UE 406 receives from the server 402. The server 402 and the base station 404 may communicate over a bidirectional communication link 410 (e.g., 126). The UE 406 and the base station 404 may communicate via a wireless communication link 416 (e.g., 122). The UE 406 may receive streaming data 412 sent from the server 402 in a downlink portion of the wireless communication link 416. The UE 406 may transmit uplink control packets 414 in an uplink portion of the wireless communication link 416.

FIG. 4B is a block diagram illustrating an example protocol stack 420 suitable for implementing any of the various embodiments. With reference to FIGS. 1A-4B, a processor of a UE (e.g., 120a-120e, 320, 406) may execute the protocol stack 420, various layers of which may enable the UE to perform data streaming operations for a streaming application. The protocol stack 420 is illustrated as a WebRTC protocol stack for illustrative purposes, but this is not intended to be limiting, and other suitable protocol stacks may include the same or similar elements. The protocol stack 420 enables a UE to support (perform, execute) low latency services and applications via a web browser application.

The protocol stack 420 may include two verticals, for an RTCPeerConnection API 422 interface, and for a (WebRTC) data channel 424. An RTCPeerConnection API 422 instance may enable an application to establish peer-to-peer communications with another real time transport protocol (RTP) peer connection instance executing on another computing device (e.g., in a browser application or another application implementing suitable protocols). The RTCPeerConnection API 422 may encrypt data using SRTP 426. The data channel vertical 424 may implement SCTP 428 to perform data congestion and data flow control operations. Either or both of the RTCPeerConnection API 422 and the data channel 424 may employ data transport layer security (DTLS) 430 to negotiate a session and exchange data securely between with another (e.g., peer) computing device.

The protocol stack 420 may enable the use of various network traversal protocols 432, including Session Traversal Utilities for NAT (STUN), Traversal Using Relays around NAT (TURN), and Interactive Connectivity Establishment (ICE). Network Address Translation (NAT) is a technique by which a router remaps a public IP address space into a private IP address space by translating IP addresses in packet headers without altering packet contents. The STUN protocol enables a device to discover its public IP address. The TURN protocol enables a server to relay data packets between devices. The ICE protocol enables a device to communicate its public IP address and connect to other devices. Data packets may be transported using a transport protocol 434 such as User Datagram Protocol (UDP) and a network layer protocol 436 such as Internet Protocol (IP).

SCTP 428 data streams may experience by Head-Of-Line (HOL) blocking at a PDCP layer (e.g., 312). In some implementations, SCTP 428 may enable packets from different data flows to be delivered independently. However, some default bearers (such as 5G default bearers) may be configured to deliver data packets only in-order, which may negate any benefits otherwise afforded to data packets handled by SCTP 428.

However, attempting to remove HOL blocking in stacks such as the protocol stack 420 may negatively affect SCTP performance. For example, up to 10 percent of data packets may arrive out of order. Further, procedures such as SCTP fast retransmission and congestion window decrease may be triggered more frequently. Also, SCTP retransmission procedures may stall a transmit (Tx) window (e.g., based on Round Trip Time (RTT)) and interrupt a pending data transmission. Moreover, RLC layer retransmissions, which may be implemented in 5G and more advanced cellular systems, may make SCTP retransmissions redundant. The occurrence of some or all of the above may decrease streaming data throughput and/or data rates for a streaming application or service. Additionally, frequent transmissions of SCTP acknowledgement messages (SCTP ACKs) may increase power consumption of a UE's battery. SCTP congestion control mechanisms also may starve a streaming application of a required minimum throughput or data rate for a streaming application. For example, SCTP congestion control mechanisms may cause a mismatch between video streaming data and a video frame size, creating a data bottleneck. As another example, SCTP congestion control mechanisms may not adapt quickly to poor wireless link RF conditions to provide the required minimum data for a streaming application.

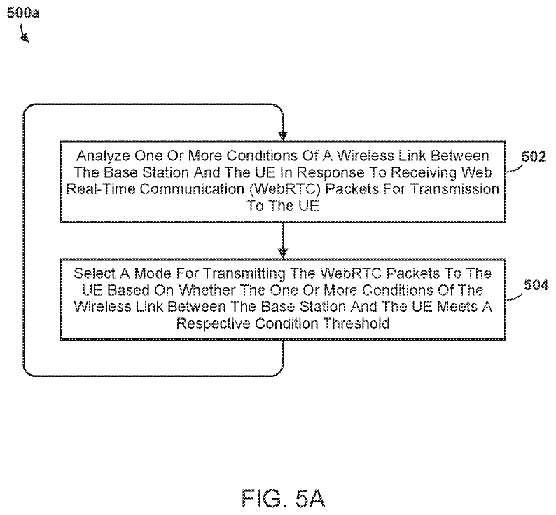

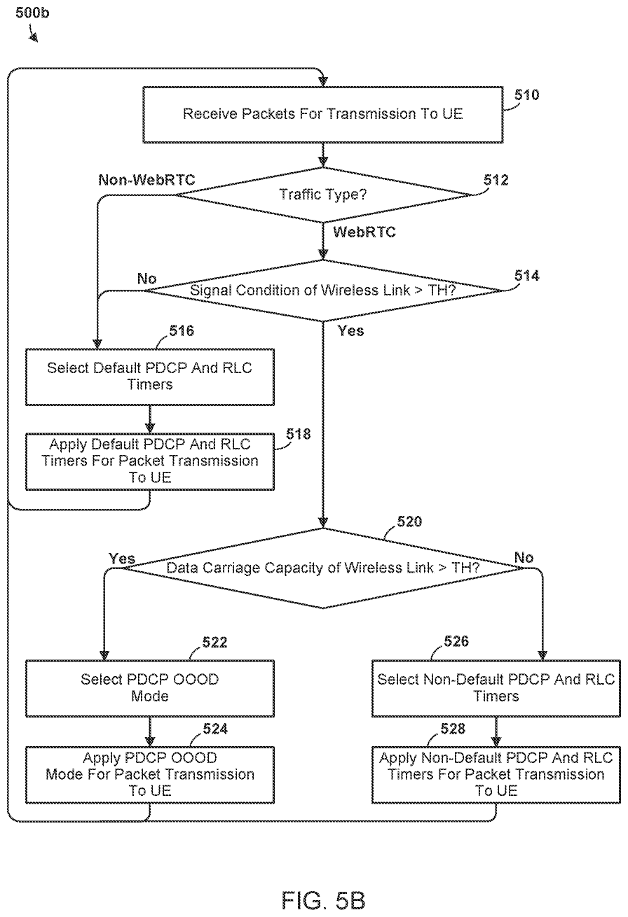

FIG. 5A is a process flow diagram illustrating a method 500a that may be performed by a processor of a base station for managing packet transmissions to a UE in accordance with various embodiments. With reference to FIGS. 1A-5A, the operations of the method 500a may be performed by a processor (such as the processor 210, 212, 214, 216, 218, 252, 260) of a UE (such as the UE 120a-120e, 200, 320, 406), and is referred to generally herein as a “processor.”

In block 502, the processor may analyze one or more conditions of a wireless link between the base station and the UE in response to receiving WebRTC packets for transmission to the UE.

In block 504, the processor may select a mode for transmitting the WebRTC packets to the UE based on whether the one or more conditions of the wireless link between the base station and the UE meets a respective condition threshold.

The processor may repeat the operations of blocks 502 and 504 from time to time.

FIG. 5B is a process flow diagram illustrating operations 500b that may be performed as part of the method 500a for managing packet transmissions to a UE in accordance with various embodiments. With reference to FIGS. 1A-5B, the operations 500b may be performed by a processor (such as the processor 210, 212, 214, 216, 218, 252, 260) of a UE (such as the UE 120a-120e, 200, 320, 406), and is referred to generally as a “processor.”

In block 510, the processor may receive packets for transmission to the UE.

In determination block 512, the processor may determine a traffic type of the packets for transmission to the UE. In some embodiments, the processor may determine whether the packets are WebRTC packets. In some embodiments, the processor may determine whether packets for transmission to the UE are WebRTC packets to be transmitted via an RTC peer connection or a Data Channel using, for example, Stream Control Transmission Protocol (SCTP) or another suitable protocol.

In response to determining that the packets are non-WebRTC packets (i.e., determination block 512=“Non-WebRTC”), the processor may select default PDCP and RLC timers in block 516. For example, the processor may select a 200 millisecond PDCP reordering timer and a 25 millisecond RLC reassembly timer, such as for use in a 5G NR communication network using communication links below 6 GHZ (“Sub6”).

In block 518, the processor may apply the default PDCP and RLC timers for transmission of the data packets to the UE. In response to determining that the packets are WebRTC packets (i.e., determination block 512=“WebRTC”), the processor may determine whether a signal condition of the wireless communication link between the base station and the UE exceeds (or is greater than or equal to) a condition threshold in block 514. In some embodiments, the processor may analyze the one or more conditions of the wireless link between the base station and the UE in response to determining that the received packets are WebRTC packets. In some embodiments, the processor may analyze the one or more conditions of the wireless link between the base station and the UE in response to determining that the received packets are WebRTC packets to be transmitted via an RTC peer connection or a Data Channel using, for example, SCTP or another suitable protocol. In some embodiments, the processor may determine whether a signal condition of the wireless link between the base station and the UE meets a signal condition threshold, for example whether an RSRP exceeds (or is greater than or equal to) an RSRP threshold, whether a block error rate (BLER) exceeds (or is greater than or equal to) a BLER threshold, and/or whether another signal condition exceeds (or is greater than or equal to) another signal condition threshold.

In response to determining that the signal condition of the wireless communication link does not exceed the condition threshold, (i.e., determination block 514=“No”), the processor may select default PDCP and RLC timers in block 516, and apply the default PDCP and RLC timers for packet transmission to the UE in block 518, as described.

In response to determining that the signal condition of the wireless link exceeds (or is greater than or equal to) the condition threshold, (i.e., determination block 514=“Yes”), the processor may determine whether a data carriage capacity of the wireless link between the base station and the UE exceeds (or is greater than or equal to) a data carriage capacity threshold in determination block 520. For example, the processor may determine whether a throughput provided by the wireless communication link meets a minimum throughput requirement (i.e., a throughput threshold) of an application or service. In some embodiments, the condition threshold may be application-specific or service specific.

In response to determining that the data carriage capacity of the wireless link between the base station and the UE exceeds (or is greater than or equal to) the data carriage capacity threshold (i.e., determination block 520=“Yes”), the processor may select a PDCP Out Of Order Delivery (OOOD) mode for packet delivery to the UE in block 522.

In block 524, the processor may apply the PDCP OOOD mode for packet transmission to the UE.

In response to determining that the data carriage capacity of the wireless link between the base station and the UE does not exceed the data carriage capacity threshold (i.e., determination block 520=“No”), the processor may select non-default PDCP and RLC timers in block 526. In some embodiments, the processor may select a value for the PDCP timer and a value for the RLC timer for transmitting WebRTC packets via an RTC peer connection or a Data Channel using, for example, SCTP or another suitable protocol. The non-default PDCP and RLC timers are different than the default PDCP and RLC timers selected in the operations of block 516. In some embodiments, default values are used for generic TCP packets, which are different from WebRTC packets transmitted via an RTC peer connection or a Data Channel using SCTP or another suitable protocol. Generic TCP packets may sustain longer retransmission delay but require higher reliability. In some embodiments, the non-default PDCP and RLC timers may be selected to accommodate multiple MAC and RLC retransmission delays. For example, the processor may select a 200 millisecond PDCP reordering timer and a 25 ms RLC reassembly timer, such as for use in a 5G NR communication network using Sub6 communication links (i.e., below 6 GHz).

In block 528, the processor may apply the PDCP OOOD mode for packet transmission to the UE.

After performing the operations of block 518, block 524, or block 528, the processor may again receive packets for transmission to the UE in block 510 as described. The processor may repeat the operations 500b from time to time.

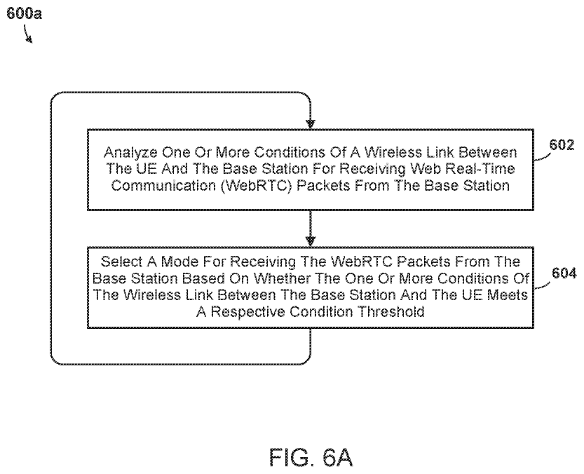

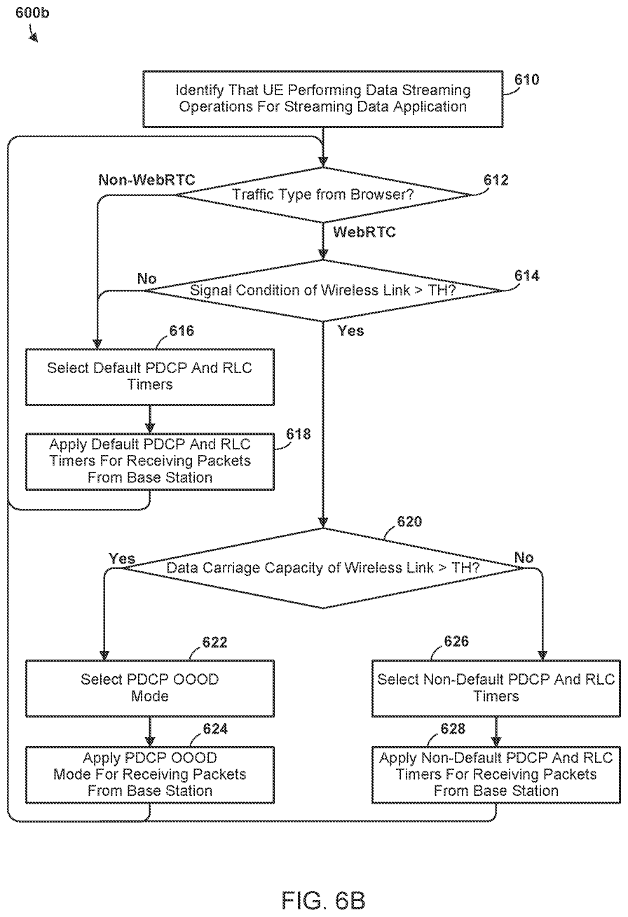

FIG. 6A is a process flow diagram illustrating a method 600a that may be performed by a processor of a UE for managing packet transmissions from a base station in accordance with various embodiments. With reference to FIGS. 1A-6A, the operations of the method 600a may be performed by a processor (such as the processor 210, 212, 214, 216, 218, 252, 260) of a base station (such as the base station 110a-110d, 200, 350, 404), and is referred to generally as a “processor.”

In block 602, the processor may analyze one or more conditions of a wireless link between the UE and the base station for receiving WebRTC packets from to the base station.

In block 604, the processor may select a mode for receiving the WebRTC packets from the base station based on whether the one or more conditions of the wireless link between the base station and the UE meets a respective condition threshold.

The processor may repeat the operations of blocks 602 and 604 from time to time.

FIG. 6B is a process flow diagram illustrating operations 600b that may be performed as part of the method 600a for managing packet transmissions to a base station in accordance with various embodiments. With reference to FIGS. 1A-5B, the operations 600b may be performed by a processor (such as the processor 210, 212, 214, 216, 218, 252, 260) of a UE (such as the UE 120a-120e, 200, 320, 406), and is referred to generally as a “processor.”

In block 610, the processor may identify that the UE is performing data streaming operations for a streaming data application. For example, the processor may determine that the UE is performing operations for an application or service that requires a high data rate and/or low data latency, such as online gaming, multimedia streaming, video conferencing, or another suitable application or service. In some embodiments, the processor may receive an indication from the streaming data application (e.g., via a cross-layer API) that the streaming data application receives, will receive, expects, and/or requires WebRTC packets (e.g., via an RTC peer connection or a Data Channel) using, for example, SCTP or another suitable protocol. In some embodiments, the processor may learn to identify WebRTC packets (e.g., via an RTC peer connection or a Data Channel) using, for example, SCTP or another suitable protocol using a learning algorithm (e.g., a machine learning algorithm).

In determination block 612, the processor may determine a traffic type of the packets for transmission to the base station (e.g., from an application or service executing in a web browser application in the UE). In some embodiments, the processor may determine whether the packets are WebRTC packets. In some embodiments, the processor may determine whether the packets are SCTP packets.

In response to determining that the packets are non-WebRTC packets (i.e., determination block 612=“Non-WebRTC”), the processor may select default PDCP and RLC timers in block 516.

In block 618, the processor may apply the default PDCP and RLC timers for receiving packets from the base station. Some embodiments may include providing received packets to an application executing in the UE according to the default PDCP and RLC timers.

In response to determining that the packets are WebRTC packets (i.e., determination block 612=“WebRTC”), the processor may determine whether a signal condition of the wireless communication link between the base station and the UE exceeds (or is greater than or equal to) a condition threshold in block 614. In some embodiments, the processor may analyze the one or more conditions of the wireless link between the UE and the base station in response to determining that the received packets are WebRTC packets. In some embodiments, the processor may analyze the one or more conditions of the wireless link between the UE and the base station in response to determining that the received packets are SCTP packets. In some embodiments, the processor may determine whether a signal condition of the wireless link between the UE and the base station meets a signal condition threshold, for example whether an RSRP exceeds (or is greater than or equal to) an RSRP threshold, whether a block error rate (BLER) exceeds (or is greater than or equal to) a BLER threshold, and/or whether another signal condition exceeds (or is greater than or equal to) another signal condition threshold.

In response to determining that the signal condition of the wireless communication link does not exceed the condition threshold, (i.e., determination block 614=“No”), the processor may select default PDCP and RLC timers in block 616, and may apply the default PDCP and RLC timers for receiving packets from the base station in block 618, as described.

In response to determining that the signal condition of the wireless link exceeds (or is greater than or equal to) the condition threshold, (i.e., determination block 614=“Yes”), the processor may determine whether a data carriage capacity of the wireless link between the UE and the base station exceeds (or is greater than or equal to) a data carriage capacity threshold in determination block 620. For example, the processor may determine whether a throughput provided by the wireless communication link meets a minimum throughput requirement (i.e., a throughput threshold) of an application or service. In some embodiments, the condition threshold may be application-specific or service specific.

In response to determining that the data carriage capacity of the wireless link between the UE and the base station exceeds (or is greater than or equal to) the data carriage capacity threshold (i.e., determination block 620=“Yes”), the processor may select a PDCP Out Of Order Delivery (OOOD) mode for receiving the packets from the base station in block 622.

In block 624, the processor may apply the PDCP OOOD mode for receiving the packets from the base station. In some embodiments, applying the PDCP OOOD mode for receiving the packets from the base station may include providing received packets to an application executing in the UE according to the PDCP OOOD mode.

In response to determining that the data carriage capacity of the wireless link between the base station and the UE does not exceed the data carriage capacity threshold (i.e., determination block 620=“No”), the processor may select non-default PDCP and RLC timers in block 626. In some embodiments, the processor may select a value for the PDCP timer and a value for the RLC timer for receiving WebRTC packets via an RTC peer connection or a Data Channel using, for example, SCTP or another suitable protocol. The non-default PDCP and RLC timers are different than the default PDCP and RLC timers selected in the operations of block 516.

In some embodiments, the non-default PDCP and RLC timers may be selected to accommodate multiple MAC and RLC retransmission delays. For example, the processor may select a 200 millisecond PDCP reordering timer and a 25 ms RLC reassembly timer, such as for use in a 5G NR communication network using Sub6 communication links (i.e., below 6 GHz).

In block 628, the processor may apply the non-default PDCP and RLC timers for receiving packets from the base station. In some embodiments, applying the non-default PDCP and RLC timers for receiving packets from the base station may include providing received packets to an application executing in the UE according to the non-default PDCP and RLC timers.

After performing the operations of block 618, block 624, or block 628, the processor may again determine a traffic type of the packets for transmission to the base station in determination block 612. The processor may repeat the operations of blocks 612-628 from time to time.

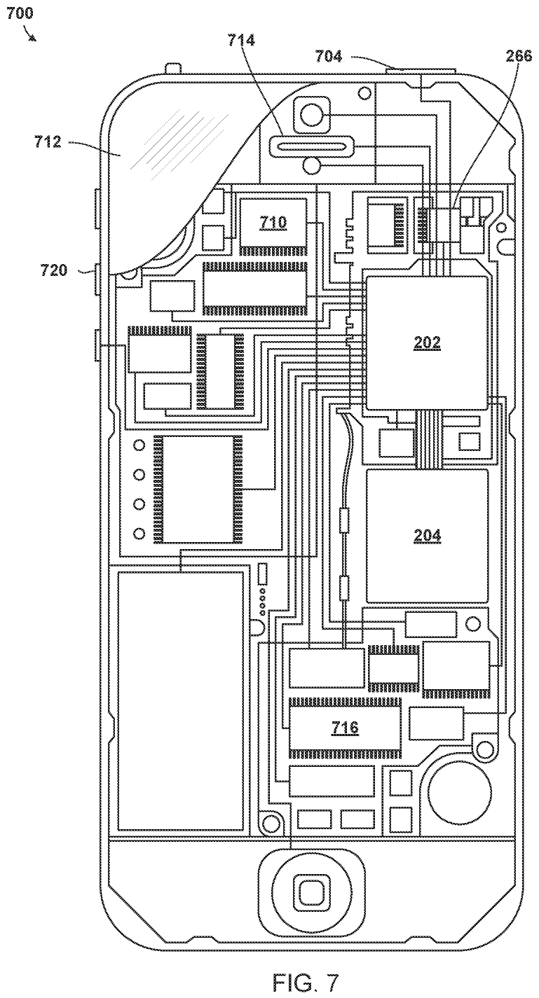

FIG. 7 is a component block diagram of a UE 700 suitable for use with various embodiments. With reference to FIGS. 1A-7, various embodiments may be implemented on a variety of UEs 700 (for example, the UEs 120a-120e, 200, 320, 402, 404), an example of which is illustrated in FIG. 7 in the form of a smartphone. The UE 700 may include a first SOC 202 (for example, a SOC-CPU) coupled to a second SOC 204 (for example, a 5G capable SOC). The first and second SOCs 202, 204 may be coupled to internal memory 716, a display 712, and to a speaker 714. Additionally, the UE 700 may include an antenna 704 for sending and receiving electromagnetic radiation that may be connected to a wireless transceiver 266 coupled to one or more processors in the first and/or second SOCs 202, 204. The UE 700 may include menu selection buttons or rocker switches 720 for receiving user inputs. The UE 700 may include a sound encoding/decoding (CODEC) circuit 710, which digitizes sound received from a microphone into data packets suitable for wireless transmission and decodes received sound data packets to generate analog signals that are provided to the speaker to generate sound. One or more of the processors in the first and second SOCs 202, 204, wireless transceiver 266 and CODEC 710 may include a digital signal processor (DSP) circuit (not shown separately).

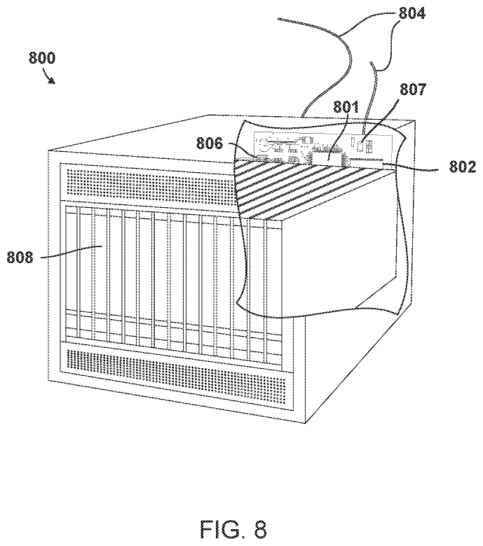

FIG. 8 is a component block diagram of a network device suitable for use with various embodiments. Such network devices (e.g., network device 110a-110d, 350, 406, 410, 414) may include at least the components illustrated in FIG. 8. With reference to FIGS. 1A-8, the network device 800 may typically include a processor 801 coupled to volatile memory 802 and a large capacity nonvolatile memory, such as a disk drive 808. The network device 800 also may include a peripheral memory access device 806 such as a floppy disc drive, compact disc (CD) or digital video disc (DVD) drive coupled to the processor 801. The network device 800 also may include network access ports 804 (or interfaces) coupled to the processor 801 for establishing data connections with a network, such as the Internet or a local area network coupled to other system computers and servers. The network device 800 may include one or more antennas 807 for sending and receiving electromagnetic radiation that may be connected to a wireless communication link. The network device 800 may include additional access ports, such as USB, Firewire, Thunderbolt, and the like for coupling to peripherals, external memory, or other devices.

The processors of the UE 700 and the network device 800 may be any programmable microprocessor, microcomputer or multiple processor chip or chips that can be configured by software instructions (applications) to perform a variety of functions, including the functions of some implementations described below. In some wireless devices, multiple processors may be provided, such as one processor within an SOC 204 dedicated to wireless communication functions and one processor within an SOC 202 dedicated to running other applications. Software applications may be stored in the memory 716, 808 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the methods and operations disclosed herein may be substituted for or combined with one or more operations of the methods and operations disclosed herein.

Implementation examples are described in the following paragraphs. While some of the following implementation examples are described in terms of example methods, further example implementations may include: the example methods discussed in the following paragraphs implemented by a base station or a UE including a processor configured with processor-executable instructions to perform operations of the methods of the following implementation examples; the example methods discussed in the following paragraphs implemented by a base station or a UE including means for performing functions of the methods of the following implementation examples; and the example methods discussed in the following paragraphs may be implemented as a non-transitory processor-readable storage medium having stored thereon processor-executable instructions configured to cause a processor of a base station or a UE to perform the operations of the methods of the following implementation examples.

Example 1. A method performed by a processor of a base station for managing packet transmissions to a user equipment (UE), including, analyzing one or more conditions of a wireless link between the base station and the UE in response to receiving Web Real-Time Communication (WebRTC) packets for transmission to the UE and selecting a mode for transmitting the WebRTC packets to the UE based on whether the one or more conditions of the wireless link between the base station and the UE meets a respective condition threshold.

Example 2. The method of example 1, in which analyzing the one or more conditions of the wireless link between the base station and the UE in response to receiving WebRTC packets for transmission to the UE includes, determining whether received packets are WebRTC packets, and analyzing the one or more conditions of the wireless link between the base station and the UE in response to determining that the received packets are WebRTC packets.

Example 3. The method of either of examples 1 or 2, in which analyzing the one or more conditions of the wireless link between the base station and the UE in response to receiving WebRTC packets for transmission to the UE includes, determining whether received packets for transmission to the UE are Stream Control Transmission Protocol (SCTP) packets, and analyzing the one or more conditions of the wireless link between the base station and the UE in response to determining that the received packets are SCTP packets.

Example 4. The method of any of examples 1-3, in which analyzing the one or more conditions of the wireless link between the base station and the UE includes determining whether a signal condition of the wireless link between the base station and the UE meets a signal condition threshold.

Example 5. The method of any of examples 1-4, in which analyzing the one or more conditions of the wireless link between the base station and the UE includes determining whether a data carriage capacity of the wireless link between the base station and the UE meets a carriage capacity threshold.

Example 6. The method of example 5, in which selecting the mode for transmitting the WebRTC packets to the UE includes selecting a Radio Link Control (RLC) timer that is different from a default RLC timer and a Packet Data Convergence Protocol (PDCP) timer that is different from a default PDCP timer in response to determining that the data carriage capacity of the wireless link between the base station and the UE does not meet the carriage capacity threshold.

Example 7. The method of example 5, in which selecting the mode for transmitting the WebRTC packets to the UE includes transmitting the WebRTC packets to the UE using a Packet Data Convergence Protocol (PDCP) out-of-order delivery (OOOD) mode in response to determining that the data carriage capacity of the wireless link between the base station and the UE meets the carriage capacity threshold.

Example 8. The method of any of examples 1-7, in which analyzing the one or more conditions of the wireless link between the base station and the UE is performed in response to receiving WebRTC packets for transmission to the UE via an RTC peer connection or a Data Channel using Stream Control Transmission Protocol (SCTP).

Example 9. A method performed by a processor of a user equipment (UE) for managing packet transmissions from a base station, including analyzing one or more conditions of a wireless link between the UE and the base station for receiving Web Real-Time Communication (WebRTC) packets from the base station, and selecting a mode for receiving the WebRTC packets from the base station based on whether the one or more conditions of the wireless link between the base station and the UE meets a respective condition threshold.

Example 10. The method of example 9, in which analyzing the one or more conditions of the wireless link between the UE and the base station for receiving WebRTC packets from the base station includes determining whether a signal condition of the wireless link between UE and the base station meets a signal condition threshold.

Example 11. The method of either of examples 9 or 10, in which analyzing the one or more conditions of the wireless link between the UE and the base station for receiving WebRTC packets from the base station includes determining whether a data carriage capacity of the wireless link between the UE and the base station meets a carriage capacity threshold.

Example 12. The method of example 11, in which selecting the mode for receiving the WebRTC packets from the base station includes selecting a Radio Link Control (RLC) timer that is different from a default RLC timer and a Packet Data Convergence Protocol (PDCP) timer that is different from a default PDCP timer in response to determining that the data carriage capacity of the wireless link between the UE and the base station does not meet the carriage capacity threshold.

Example 13. The method of example 11, in which selecting the mode for receiving the WebRTC packets from the base station includes selecting an RLC Radio Link Control (RLC) timer that is different from a default RLC timer and a Packet Data Convergence Protocol (PDCP) timer that is different from a default PDCP timer and receiving the WebRTC packets using a Packet Data Convergence Protocol (PDCP) out-of-order delivery (OOOD) mode in response to determining that the data carriage capacity of the wireless link between the UE and the base station meets the carriage capacity threshold.

Example 14. The method of any of examples 9-13, in which analyzing the one or more conditions of the wireless link between the UE and the base station for receiving Web Real-Time Communication (WebRTC) packets from the base station includes analyzing the one or more conditions of the wireless link between the UE and the base station for receiving WebRTC packets from the base station via an RTC peer connection or a Data Channel using Stream Control Transmission Protocol (SCTP).

Example 15. The method of any of examples 9-14, further including providing received WebRTC packets to an application executing in the UE according to the selected mode.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running in a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method performed by a processor of a base station for managing packet transmissions to a user equipment (UE), comprising:
analyzing one or more conditions of a wireless link between the base station and the UE in response to receiving Web Real-Time Communication (WebRTC) packets for transmission to the UE; and
selecting a mode for transmitting the WebRTC packets to the UE based on whether the one or more conditions of the wireless link between the base station and the UE meets a respective condition threshold.

2. The method of claim 1, wherein analyzing the one or more conditions of the wireless link between the base station and the UE in response to receiving WebRTC packets for transmission to the UE comprises:
determining whether received packets are WebRTC packets; and
analyzing the one or more conditions of the wireless link between the base station and the UE in response to determining that the received packets are WebRTC packets.

3. The method of claim 1, wherein analyzing the one or more conditions of the wireless link between the base station and the UE in response to receiving WebRTC packets for transmission to the UE comprises:
determining whether received packets for transmission to the UE are Stream Control Transmission Protocol (SCTP) packets; and
analyzing the one or more conditions of the wireless link between the base station and the UE in response to determining that the received packets are SCTP packets.

4. The method of claim 1, wherein analyzing the one or more conditions of the wireless link between the base station and the UE comprises determining whether a signal condition of the wireless link between the base station and the UE meets a signal condition threshold.

5. The method of claim 1, wherein analyzing the one or more conditions of the wireless link between the base station and the UE comprises determining whether a data carriage capacity of the wireless link between the base station and the UE meets a carriage capacity threshold.

6. The method of claim 5, wherein selecting the mode for transmitting the WebRTC packets to the UE comprises selecting a Radio Link Control (RLC) timer that is different from a default RLC timer and a Packet Data Convergence Protocol (PDCP) timer that is different from a default PDCP timer in response to determining that the data carriage capacity of the wireless link between the base station and the UE does not meet the carriage capacity threshold.

7. The method of claim 5, wherein selecting the mode for transmitting the WebRTC packets to the UE comprises transmitting the WebRTC packets to the UE using a Packet Data Convergence Protocol (PDCP) out-of-order delivery (OOOD) mode in response to determining that the data carriage capacity of the wireless link between the base station and the UE meets the carriage capacity threshold.

8. The method of claim 1, wherein analyzing the one or more conditions of the wireless link between the base station and the UE is performed in response to receiving WebRTC packets for transmission to the UE via an RTC peer connection or a Data Channel using Stream Control Transmission Protocol (SCTP).

9. A base station, comprising:
a processor configured with processor-executable instructions to:
analyze one or more conditions of a wireless link between the base station and a user equipment (UE) in response to receiving Web Real-Time Communication (WebRTC) packets for transmission to the UE; and
select a mode for transmitting the WebRTC packets to the UE based on whether the one or more conditions of the wireless link between the base station and the UE meets a respective condition threshold.

10. The base station of claim 9, wherein the processor is further configured with processor-executable instructions to:
determine whether received packets are WebRTC packets; and
analyze the one or more conditions of the wireless link between the base station and the UE in response to determining that the received packets are WebRTC packets.

11. The base station of claim 9, wherein the processor is further configured with processor-executable instructions to:
determine whether received packets for transmission to the UE are Stream Control Transmission Protocol (SCTP) packets; and
analyze the one or more conditions of the wireless link between the base station and the UE in response to determining that the received packets are SCTP packets.

12. The base station of claim 9, wherein the processor is further configured with processor-executable instructions to determine whether a signal condition of the wireless link between the base station and the UE meets a signal condition threshold.

13. The base station of claim 9, wherein the processor is further configured with processor-executable instructions to determine whether a data carriage capacity of the wireless link between the base station and the UE meets a carriage capacity threshold.

14. The base station of claim 13, wherein the processor is further configured with processor-executable instructions to select a Radio Link Control (RLC) timer that is different from a default RLC timer and a Packet Data Convergence Protocol (PDCP) timer that is different from a default PDCP timer in response to determining that the data carriage capacity of the wireless link between the base station and the UE does not meet the carriage capacity threshold.

15. The base station of claim 13, wherein the processor is further configured with processor-executable instructions to transmit the WebRTC packets to the UE using a Packet Data Convergence Protocol (PDCP) out-of-order delivery (OOOD) mode in response to determining that the data carriage capacity of the wireless link between the base station and the UE meets the carriage capacity threshold.

16. The base station of claim 9, wherein the processor is further configured with processor-executable instructions to analyze the one or more conditions of the wireless link between the base station and the UE in response to receiving WebRTC packets for transmission to the UE via an RTC peer connection or a Data Channel using Stream Control Transmission Protocol (SCTP).

17. A method performed by a processor of a user equipment (UE) for managing packet transmissions received from a base station, comprising:
analyzing one or more conditions of a wireless link between the UE and the base station for receiving Web Real-Time Communication (WebRTC) packets from the base station; and
selecting a mode for receiving the WebRTC packets from the base station based on whether the one or more conditions of the wireless link between the base station and the UE meets a respective condition threshold.

18. The method of claim 17, wherein analyzing the one or more conditions of the wireless link between the UE and the base station for receiving WebRTC packets from the base station comprises determining whether a signal condition of the wireless link between UE and the base station meets a signal condition threshold.

19. The method of claim 17, wherein analyzing the one or more conditions of the wireless link between the UE and the base station for receiving WebRTC packets from the base station comprises determining whether a data carriage capacity of the wireless link between the UE and the base station meets a carriage capacity threshold.

20. The method of claim 19, wherein selecting the mode for receiving the WebRTC packets from the base station comprises selecting a Radio Link Control (RLC) timer that is different from a default RLC timer and a Packet Data Convergence Protocol (PDCP) timer that is different from a default PDCP timer in response to determining that the data carriage capacity of the wireless link between the UE and the base station does not meet the carriage capacity threshold.

21. The method of claim 19, wherein selecting the mode for receiving the WebRTC packets from the base station comprises selecting an RLC Radio Link Control (RLC) timer that is different from a default RLC timer and a Packet Data Convergence Protocol (PDCP) timer that is different from a default PDCP timer and receiving the WebRTC packets using a Packet Data Convergence Protocol (PDCP) out-of-order delivery (OOOD) mode in response to determining that the data carriage capacity of the wireless link between the UE and the base station meets the carriage capacity threshold.

22. The method of claim 17, wherein analyzing the one or more conditions of the wireless link between the UE and the base station for receiving Web Real-Time Communication (WebRTC) packets from the base station comprises analyzing the one or more conditions of the wireless link between the UE and the base station for receiving WebRTC packets from the base station via an RTC peer connection or a Data Channel using Stream Control Transmission Protocol (SCTP).

23. The method of claim 17, further comprises providing received WebRTC packets to an application executing in the UE according to the selected mode.

24. A user equipment (UE), comprising:
a processor configured with processor-executable instructions to:
analyze one or more conditions of a wireless link between the UE and a base station for receiving Web Real-Time Communication (WebRTC) packets from the base station; and
select a mode for receiving the WebRTC packets from the base station based on whether the one or more conditions of the wireless link between the base station and the UE meets a respective condition threshold.

25. The UE of claim 24, wherein the processor is further configured with processor-executable instructions to determine whether a signal condition of the wireless link between UE and the base station meets a signal condition threshold.

26. The UE of claim 24, wherein the processor is further configured with processor-executable instructions to determine whether a data carriage capacity of the wireless link between the UE and the base station meets a carriage capacity threshold.

27. The UE of claim 26, wherein the processor is further configured with processor-executable instructions to select a Radio Link Control (RLC) timer that is different from a default RLC timer and a Packet Data Convergence Protocol (PDCP) timer that is different from a default PDCP timer in response to determining that the data carriage capacity of the wireless link between the UE and the base station does not meet the carriage capacity threshold.

28. The UE of claim 26, wherein the processor is further configured with processor-executable instructions to select a Radio Link Control (RLC) timer that is different from a default RLC timer and a Packet Data Convergence Protocol (PDCP) timer that is different from a default PDCP timer and receive the WebRTC packets using a Packet Data Convergence Protocol (PDCP) out-of-order delivery (OOOD) mode in response to determining that the data carriage capacity of the wireless link between the UE and the base station meets the carriage capacity threshold.

29. The UE of claim 24, wherein the processor is further configured with processor-executable instructions to analyze the one or more conditions of the wireless link between the UE and the base station for receiving WebRTC packets from the base station via an RTC peer connection or a Data Channel using Stream Control Transmission Protocol (SCTP).

30. The UE of claim 24, wherein the processor is further configured with processor-executable instructions to provide received WebRTC packets to an application executing in the UE according to the selected mode.
